(19) United States
(12) Patent Application Publication
(10) Pub. No.: US 2011/0091160 A1
(43) Pub. Date: Apr. 21, 2011

(54) OPTICAL CONNECTOR WITH LESS CROSSTALK BETWEEN THERMINALS THEREOF

(75) Inventors: JIA-YONG HE, Kunshan (CN); QI-SHENG ZHENG, Kunshan (CN)

(73) Assignee: HON HAI PRECISION INDUSTRY CO., LTD., Tu-Cheng (TW)

(21) Appl. No.: 12/907,051

(22) Filed: Oct. 19, 2010

(30) Foreign Application Priority Data
Oct. 19, 2009 (CN) 200910308424.3
Oct. 19, 2009 (CN) 200920312676.9

(51) Int. Cl. G02B 6/38

(52) U.S. Cl. 385/74; 385/75

(57) ABSTRACT

An optical connector comprises an insulative housing defining a mating port, at least one grounding contact disposed on the housing, and exposed into the mating port; an optical module movably retained in the housing along a front-to-rear direction and adapted for transmitting optical signal; and a metallic resilient member located behind the optical module to constantly urge the optical module forwardly. The resilient member is electrically connected with the grounding contact and thus grounded through the grounding contact.

### BACKGROUND OF THE INVENTION

1. Field of the Invention

The present invention relates to an optical connector, more particularly to the contacts of an optical connector with less crosstalk between terminals thereof.

2. Description of Related Art

Universal Serial Bus (USB) is widely used in variety electric devices as a standard and simple interface. Until now, USB specification has went through 0.9, 1.0, 1.1, 2.0 and 3.0 versions. Speed data rate of USB connector is gradually increased at the same time for adapting the rapid development of electric industry. Recently, designers further design a new connector which is added optical fibers to USB 3.0 for supplying an even higher data rate than USB 3.0 and achieving remote signal transmission. The new connector is an optical connector, and comprises an insulative housing, USB 3.0 contacts retained on the insulative housing, an optical module retained in the insulative housing to transmit optical signal, and a compression coil spring sandwiched between the optical module and the housing along a front-to-rear direction. Therefore, the optical connector is based on USB interface and can mate with a USB connector. The optical module has a lens and a plurality of fibers partly received in the lens. The fibers extend out of a rear end of the lens to connect with a cable behind the optical connector. The insulative housing defines a receiving cavity to receive the optical module. And the optical module can move in the receiving cavity along an insertion direction of a mating connector. However, in a mating process of the mating connector, it would create static electricity on the compression coil spring while the compression coil spring is expanding and shrinking due to being biased by the optical module. Thus, It would cause more crosstalk for interfering signals transmitted between the USB 3.0 contacts.

Hence, an improved optical connector is desired to overcome the above problems.

### BRIEF SUMMARY OF THE INVENTION

In order to achieve the above-mentioned object, an optical connector in accordance with present invention comprises an insulative housing defining a mating port; at least one grounding contact disposed on the housing, and exposed into the mating port; an optical module movably retained in the housing along a front-to-rear direction and adapted for transmitting optical signal; and a metallic resilient member located behind the optical module to constantly urge the optical module forwardly; wherein the resilient member is electrically connected with the grounding contact so as to connect to a ground through the grounding contact.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an optical connector in accordance with a first embodiment of the present invention;

FIG. 2 is a partially assembled view of FIG. 1;

FIG. 3 is similar to FIG. 2, but viewed from another aspect;

FIG. 4 is similar to FIG. 2, but without an insulative cover viewed from another aspect;

FIG. 5 is a cross-sectional view of the connector taken along line 5-5 shown in FIG. 1;

FIG. 6 is an exploded view of FIG. 1 with an insulator, an outer case removal therefrom;

FIG. 7 is similar to FIG. 6, but viewed from another aspect;

FIG. 8 is a partially assembled view of the optical connector in accordance with a second embodiment of the present invention;

FIG. 9 is a partially exploded view of FIG. 8; and

FIG. 10 is an exploded view of the optical connector shown in FIG. 8.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details.

Reference will be made to the drawing figures to describe the present invention in detail, wherein depicted elements are not necessarily shown to scale and wherein like or similar elements are designated by same or similar reference numeral through the several views and same or similar terminology.

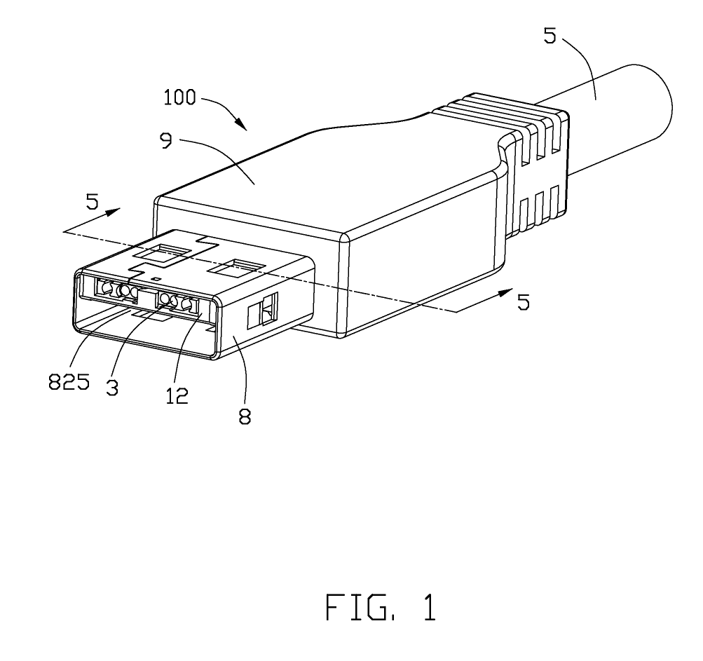

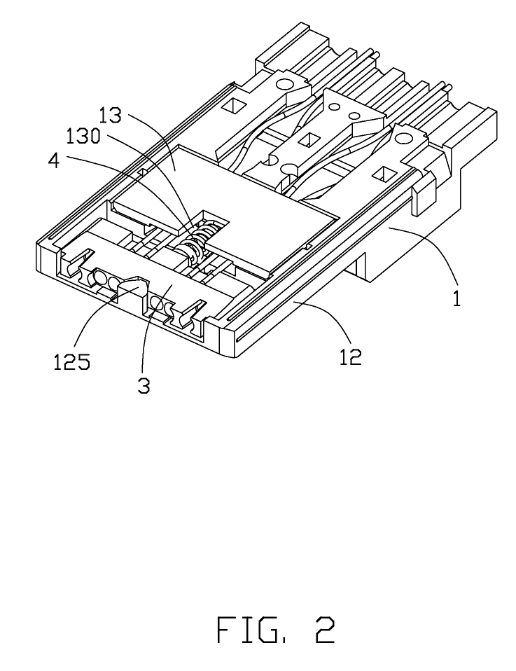

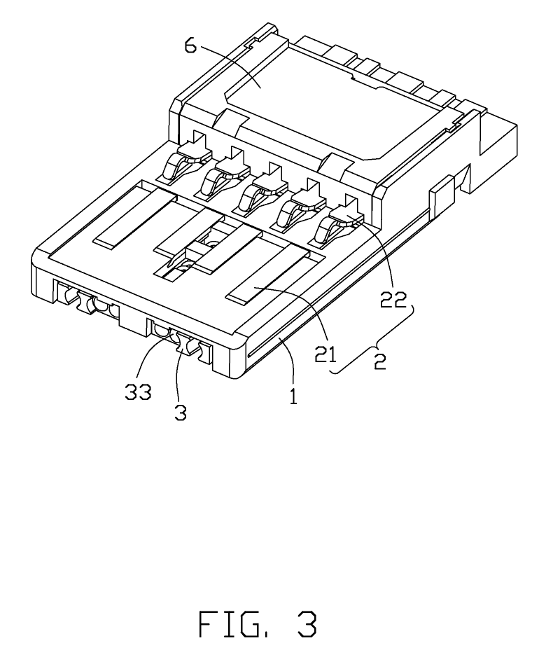

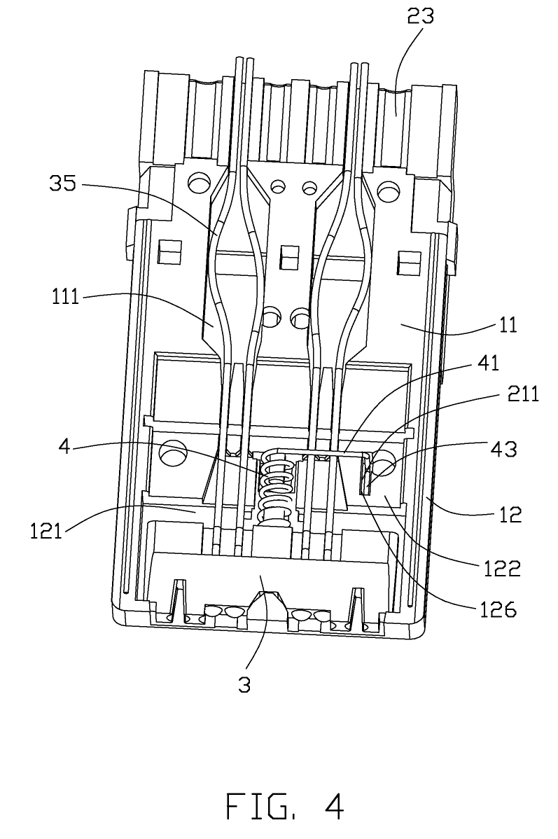

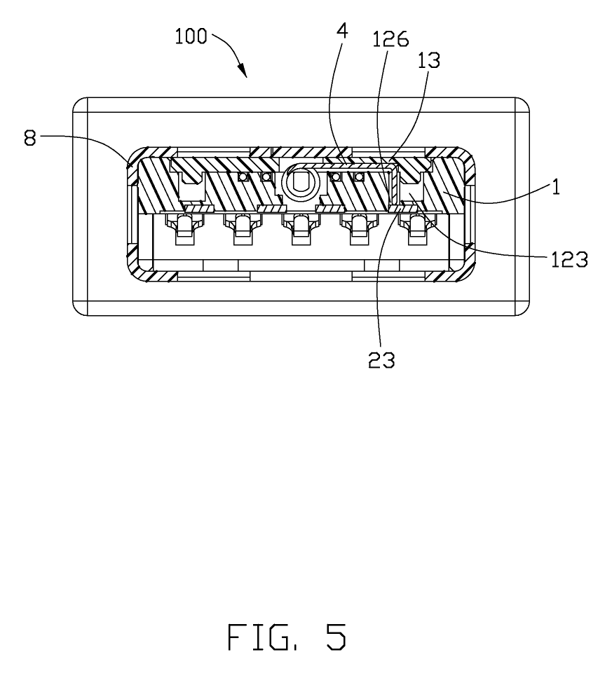

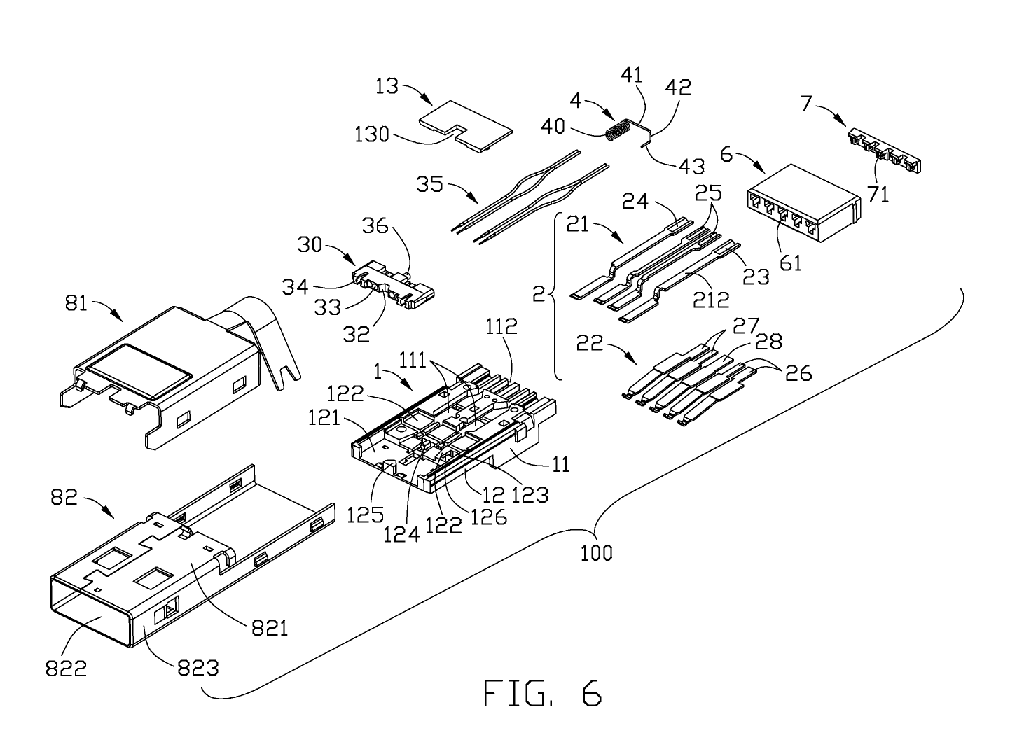

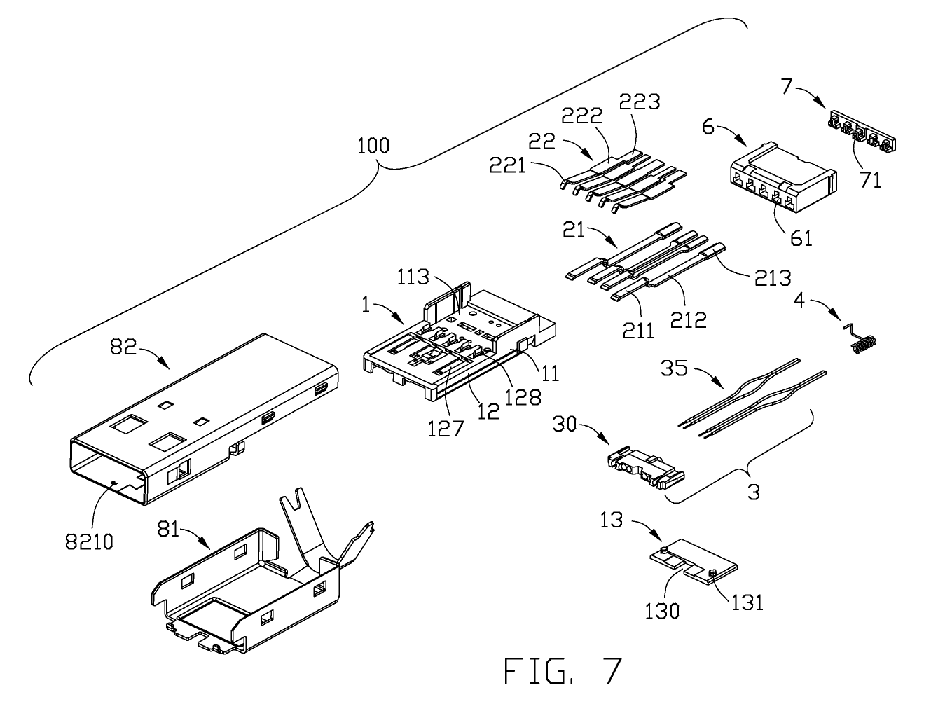

Referring to FIGS. 1-7, an optical plug connector 100 according to the first embodiment of the present invention is disclosed. The optical connector 100 comprises an insulative housing 1, a plurality of contacts 2 retained in the insulative housing 1, an optical module 3 movably retained in the insulative housing 1 along a front-to-rear direction, a resilient member 4 sandwiched between the optical module 3 and the insulative housing 1 along the front-to-rear direction, an insulator 6 retained in the insulative housing 1, a spacer 7 fastened on a rear side of the insulator 5, a metal shell 8 enclosing the insulative housing 1, an outer case 9 covering the metal shell 8, and a cable 5 connecting the contacts 2 and the optical module 3. The cable 5 has electrical wires and optical wires. Detail description of these elements and their relationship and other elements formed thereon will be detailed below.

The insulative housing 1 includes a base portion 11 and a tongue portion 12 extending forwardly from the base portion 11. A receiving slot 121 is recessed downwardly from an upper surface of the tongue portion 12. A first post 124 extends forwardly into the receiving slot 121 for retaining the resilient member 4. A stopping block 125 is formed in a front portion of the receiving slot 121. The first post 124 is located an opposite side to the stopping block 125 along the front-to-rear direction.

A depression 122 is defined in a rear portion of the tongue portion 12 and communicating with the receiving slot 121. The receiving slot 121 is deeper than the depression 122. A plurality of contact slots 112 are defined in an upper segment of a rear portion of the base portion 11. Four fiber grooves 111 are defined in the base portion 11 and extend along the front-to-rear direction, pass through a bottom wall of the depression 122 and communicate with the receiving slot 121. The bottom wall of the depression 12 defines a pair of retaining holes 123 disposed at two opposite outer sides of the fiber grooves 111, and an elongated reception groove 126 extending forwardly from one retaining hole 123. All the retaining holes 123 and the reception groove 126 are in communication with the depression 122. A cavity 113 is recessed upwardly from a bottom surface of the base portion 11. The tongue portion 12 defines a plurality of first and second passageways 127, 128 recessed upwardly from a lower surface thereof, respectively. The first passageways 127 are located at front of the second passageways 128. One of the first passageways 127 which is disposed in an outside of other first passageways 127 is in communication with the reception hole 126.

The contacts 2 are based on the USB 3.0 standard, and include a set of first contacts 21, and a set of second contacts 22. The first contacts 21 have four contact members arranged in a row along the transverse direction and consist of a first grounding contact 23, a power contact 24 for transmitting power signal, and a first pair of differential contacts 25 disposed between the first grounding contact 23 and the power contact 24 for transmitting differential signals. The first contacts 21 each substantially includes a first planar retention portion 212 supported by a bottom surface of the cavity 113, a first mating portion 211 raised upwardly and extending forwardly from the first retention portion 212 and disposed in a first passageways 127 of the tongue portion 12, and a first tail portion 213 extending rearwardly from the first retention portion 212 and accommodated in the corresponding contact slot 112 of the housing 1.

The second contacts 22 have five contact members arranged in a row along the transverse direction and combined with the insulator 5. The second contacts 22 are separated into a second pair of differential contacts 26 for transmitting differential signals, a third pair of differential contacts 27 for transmitting differential signals, and a second grounding contact 28 disposed between the two pairs of differential contacts 26, 27. The first, second, and third pair of differential contact 25, 26, 27 consist of signal contacts. The second contacts 22 each includes a second planar retention portion 222 received in corresponding groove 61 of the insulator 6, a second curved mating portion 221 extending forward from the second retention portion 222 and disposed beyond the insulator 7, and a second tail portion 223 extending rearwardly from the second retention portion 222 and disposed behind the insulator 6. A spacer 7 is assembled to a rear end of the insulator 6, with a number of ribs 71 inserted into the grooves 61 to position the second contacts 22 in the insulator 6.

The insulator 6 is mounted to the cavity 113 of the base portion 11 and presses onto the first retention portions 212 of the first contacts 21, with the second mating portions 221 located behind the first mating portions 211 and above the tongue portion 12. The second tail portions 223 are arranged on a bottom surface of the rear segment of the base portion 11 and disposed lower than the first tail portions 213.

The optical module 3 includes a holder member 30 movably in the receiving slot 121 along the front-to-rear direction, and four fibers 35 attached to the holder member 30. The holder member 30 defines a V-shaped indentation 32 recessed from a front end thereof to engage with the stopping block 125 for limiting a forward movement of the holder member 30, and a second post 36 protruding rearwardly into the receiving slot 121 from a middle portion thereof and opposite to the first post 124 of the housing 1 along the front-to-rear direction. The second post 36 is adapted to be received in the resilient member 4. Therefore, the optical module 3 could be biased forwardly by the resilient member 4.

The holder member 30 is formed with two pairs of lenses 33 at a front side thereof, and a pair of position holes 34 recessed from the front side thereof and located at two outer sides of all lenses 33 respectively. The two pairs of lenses 33 are respectively located at two outer sides of the V-shaped indentation 32. The position holes 34 are used to engage with a pair of posts on a complementary receptacle (not shown) for aligning the optical connector 100 and the complementary receptacle along the front-to-rear direction, then the lenses 33 can exactly face to lenses on the complementary receptacle for transmitting optical signals.

The fibers 35 are separated into two groups and pass through the fiber grooves 111, the depression 122, and enter the receiving slots 121, respectively. An insulative cover 13 is positioned in the depression 122 to enclose the receiving slot 121 and the fiber grooves 111 for limiting the fibers 35 from moving upwardly. Therefore the holder member 30 could be hold in the receiving slot 121 so as to be prevented from overly moving along the upper-to-lower direction. The cover 13 defines a cutout 130 recessed rearwardly from a front edge, a pair of retaining posts 131 corresponding to the pair of retaining holes 123 of the tongue portion 12.

The resilient member 4 is made of metallic material and includes a compression coil spring 40 extending along the front-to-rear direction, and a horizontal rod 41 extending sidewardly front a rear end thereof, an upright rod 42 bending downwardly and extending from a distal end of the horizontal rod 41, and a horizontal abuting rod 43 extending forwardly from a lower end of the upright rod 42.

The metal shell 8 comprises an upper shell 81 covering the base portion 11, and a lower shell 82 assembling with the upper shell 81 to enclose the insulative housing 1. The lower shell 82 encloses the tongue portion 12 and has a top wall 821 resisting the lower surface of the tongue 12, a bottom wall 822 opposed to the top wall 821 and a pair of side walls 823 bending and extending downwardly from the top wall 821 to the bottom wall 821. The top wall 821 has a barb 8210 protruding downwardly to resist the optical module 3. An electrical mating port 825 is formed among the tongue portion 12, the bottom wall 822, and the contacts 2 for receiving a tongue plate of the complementary receptacle.

The first mating portions 211 of the first contacts 21 are located in the first passageways 127 of the tongue portion 12, and exposed into the electrical mating port 825. The second mating portions 221 of the second contacts 22 are located in the second passageways 128 of the electrical mating port 825. The compression coil spring 41 is disposed in the receiving slot 121. The rear end of the compression coil 41 is attached to the first post 124 of the tongue portion 12 and partially exposed in the cutout 130 of the cover 13. A front end of the compression coil spring 41 is attached to the second post 36 of the optical module 3. The horizontal rod 41 of the resilient member 4 is located in the depression 122 and sandwiched between the cover 13 and the bottom wall of the depression 122 for being limited from moving along the upper-to-lower direction. The horizontal rod 41 is disposed above the fiber 35 for limiting the fibers 35 from floating over upwardly. The upright rod 42 and the abutting rod 43 of the resilient member 4 are received in the reception groove 126. The upright rod 42 is sandwiched between one of the pair of the retaining posts 131 of the cover 13 and an inner wall of the reception groove 126. The abuting rod 43 abuts against the first mating portion 211 of the first grounding contact 23 so as to discharge static electricity through the first grounding contact 23, thereby, crosstalk caused between the contacts 2 will be reduced reliably.

When the optical connector 100 is inserted into the complementary receptacle for mating with the complementary receptacle, the optical module 3 is pushed backwardly by the complementary receptacle and moves backwardly in the receiving slot 121. When the optical connector 100 is extracted out from the complementary receptacle, the optical module 3 is biased forwardly by the compression coil spring 4 and moves forwardly in the receiving slot 121.

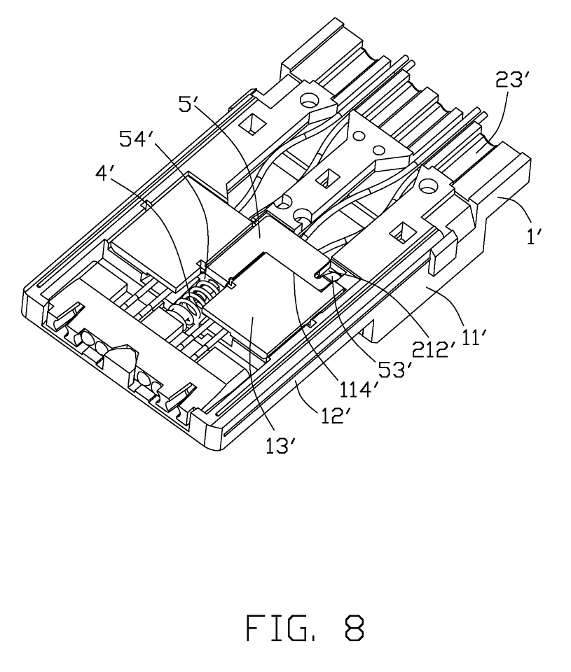

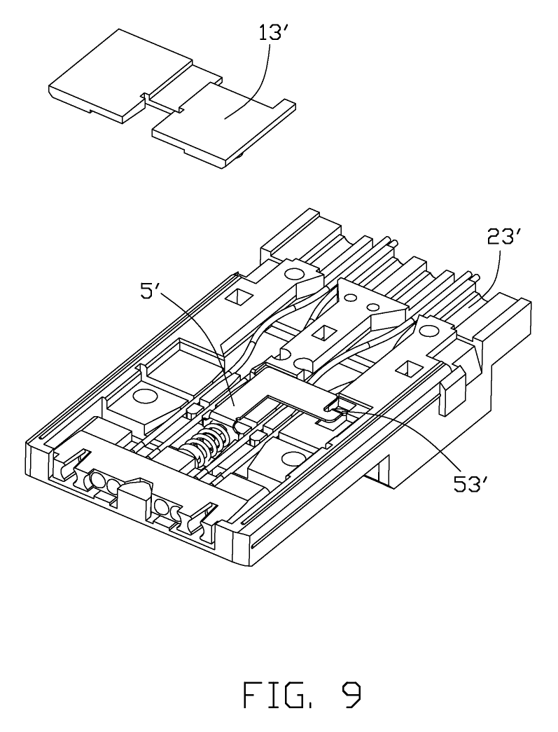

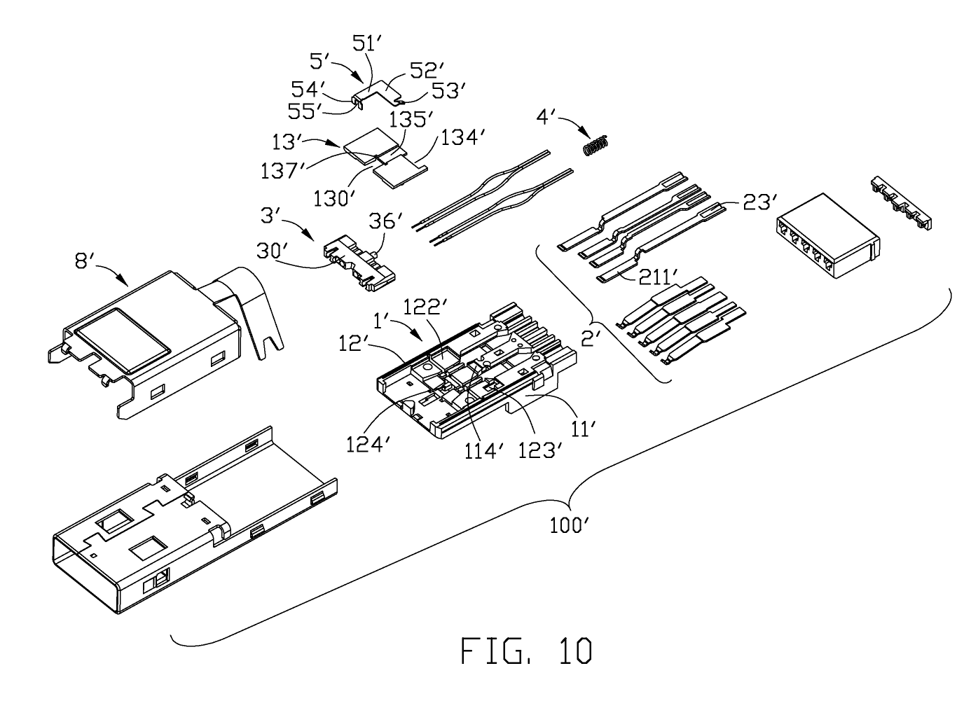

Referring to FIGS. 8-10, an optical connector 100′ according to a second embodiment is disclosed. The optical connectors 100, 100′ in the first and second embodiments are similar to each other, and have a small difference. The optical connector 100′ includes an insulative housing 1′, a plurality of contacts 2′ retained in the housing 1, an optical module 3′ movably retained in the tongue portion 12′ along a front-to-rear direction, a compression coil spring 4′ sandwiched between the optical module 3′, along the front-to-rear direction, a metallic connect plate 5′ retained in the housing 1′, and a metal shell 8′ enclosing the housing 1.

The housing 1′ includes a base portion 11′ and a tongue portion 12′ extending forwardly from the base portion 11′. The tongue portion 12′ defines a receiving slot 121′ recessed downwardly from a top surface thereof, and a first post 124′ extending forwardly into the receiving slot 121′. A depression 122′ is defined in a rear portion of the tongue portion 12′ and communicating with the receiving slot 121′. The tongue portion 12′ defines a first passageway (not shown) recessed upwardly from a lower surface thereof, and a reception groove 123′ extending upwardly from the passageways to the depression 122′. The contacts 2′ includes a first grounding contact 23′ with a first planner mating portion 211′ retained in the first passageway.

The optical module 3′ includes a holder member 30′ with a second post 36′ extending rearwardly into the receiving slot 121′. A rear end of the compression coil spring 4′ is attached to the first post 124′ of the tongue portion 12′. A front end of the compression coil spring 4′ is attached to the second post 36′ of the optical module 3′ for directly urging the optical module 3′ forwardly.

An insulative cover 13′ is retained in the depression 122′. A first retaining slot 114′ is formed between a rear end of the cover 13′ and an inner wall of the depression 122′ along the front-to-rear direction. The rear end of the cover 13′ defines a first notch 134′ communicating with the retaining slot 114′, a second retaining slot 135′ recessed from a lower surface thereof, and a second notch 130′ recessed on a front edge thereof. Both of the first notch 134′ and the second retaining slot 135′ are in communication with the first slot 114′. The second notch 130′ is in communication with the second retaining slot 135′. Two opposite inner wall of the second notch 130′ define two opposite locating slots 137′ adjacent to the second retaining slot 135′ and passing through the cover 13′ along a vertical direction of the optical connector 100′.

The connect plate 5′ is stamped from a metallic sheet, and includes a first retaining plate 51′, a second retaining plate 52′ extending sidewardly and perpendicularly from a rear end of the first retaining plate 51′, and an upright attaching plate 54′ bending and extending downwardly from a front end of the first retaining plate 52′. The first retaining plate 51′ is retained in the second retaining slot 135′ for being prevented from moving in a transverse direction perpendicular to the front-to-rear direction. The second retaining plate 52′ is retained in the first retaining slot 114′ for being prevented from moving along the front-to-rear direction. The second retaining plate 52′ defines an inclined abuting plate 53′ stamped downwardly and rearwardly from a side edge thereof. The abuting plate 53′ passes downwardly through the first notch 134′ into the reception 123′ and presses onto the first mating portion 211′ of the first grounding contact 23′. The attaching plate 54′ has two opposite side edges retained in the locating slots 137′ respectively for being prevented from moving along the front-to-rear direction. The attaching plate 54′ defines a lower cutout 55′ formed on a bottom edge thereof for the first post 124′ passing through and resisted rearwardly by the compression coil spring 4′. The compression coil spring 4′ is discharge static electricity through the grounding contact 23′, thereby, crosstalk caused between the contacts 2′ will be reduced reliably. The metal shell 8′ covers the connect plate 5′ for limiting the connect plate 5′ from moving in the vertical direction.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An optical connector, comprising:
an insulative housing defining a mating port;
at least one grounding contact disposed on the housing, and exposed into the mating port;
an optical module movably retained in the housing along a front-to-rear direction and adapted for transmitting optical signal; and
a metallic resilient member located behind the optical module to constantly urge the optical module forwardly;
wherein the resilient member is electrically connected with the grounding contact so as to connect to a ground through the grounding contact.

2. The optical connector as claimed in claim 1, wherein the resilient member is a compression coil spring sandwiched between the housing and the optical module, and defines an abuting rod extending from the compression coil spring, the abuting rod is directly in touch with the grounding contact.

3. The optical connector as claimed in claim 2, wherein the housing defines a reception groove retaining the abuting rod therein and a passageway in communication with the reception groove, the grounding contact is retained in the passageway.

4. The optical connector as claimed in claim 1, wherein the housing defines a base portion and a tongue portion extending forwardly from the base portion, the tongue portion defines a receiving slot, a depression in a rear portion thereof and communicating with the receiving slot, and a reception groove extending downwardly from the depression, the optical module is received in the receiving slot, the resilient member includes a compression coil spring, a horizontal rod extending outwardly from the compression coil spring, an upright rod extending downwardly from a distal end of the horizontal rod, and a lower abuting rod extending from the upright rod along the upright rod and being in touch with the grounding contact, the horizontal rod is received in the depression and presses rearwardly onto an inner wall of the depression, the horizontal rod and the abuting rod are received in the reception groove.

5. The optical connector as claimed in claim 4, wherein the housing includes a cover filled in the depression to abut against the horizontal rod and enclose the reception groove, the receiving slot and the depression are offset from the mating port in a vertical direction perpendicular to the front-to-rear direction respectively, the tongue portion defines a passageway communicating with the reception groove and the mating port, the grounding contact has a mating portion received in the passageway and exposed into the mating port.

6. The optical connector as claimed in claim 5, wherein the cover defines a retaining post retained into a retaining hole formed in a bottom wall of the depression and in communicating with the reception groove, the upright rod is sandwiched between the retaining post and an inner wall of the reception groove.

7. The optical connector as claimed in claim 4, wherein the housing defines at least one fiber groove recessed on the base portion, the fiber groove passes through a bottom wall of the depression, and enters communicate with the receiving slot, the optical module includes a holder member movably in the receiving slot, and at least one fiber attached to the holder member an received in the fiber groove, the holder member is formed with at least one lens at a front side thereof, the horizontal rod is above the fiber for limiting the fiber over moving upwardly.

8. The optical connector as claimed in claim 1, further comprising a metallic connect plate retained in the housing and being in touch with both of the resilient member and the grounding contact, the grounding contact is separated from the resilient member.

9. The optical connector as claimed in claim 8, wherein the housing includes a receiving slot receiving the optical module therein, a depression communicating with a rear part of the receiving slot, a passageway offset from the depression along the vertical direction, a reception groove in communication with both of the depression and the passageway, and a cover retained in the depression, the contact is retained in the passageway, the connect plate is retained on the cover and passes through the depression into the reception groove to press on the grounding contact.

10. The optical connector as claimed in claim 9, wherein the housing defines a first post extending forward into the receiving slot, the optical module defines a second post opposite to the first post, the resilient member is a compression coil spring, and have two opposite ends attached to the first and the second posts respectively, the connect plate has a retaining plate retained in the cover, an inclined abuting plate extending downwardly from a edge of the retaining plate, and an upright plate extending downwardly from another edge of the retaining plate and resisted backwardly by the resilient member, the abuting plate is located in the reception groove to press onto the grounding contact, the resilient member includes the upright plate defines a lower cutout for the first post passing through.

11. The optical connector as claimed in claim 1, further comprising a plurality of contacts retained in the housing and based on the USB 3.0 standard, the contacts include a first set of contacts, and a second set of contacts, the first contacts have a first grounding contact, a power contact, and a first pair of differential contacts disposed between the first grounding contact and the power contact, the second contacts have another two pairs of differential contacts, and a second grounding contact disposed between the two pairs of differential contacts, the resilient member is directly or indirectly electrically connected with at least one of the first and the second grounding contacts.

12. A hybrid connector for transmission of electrical and optical signals, comprising:
an insulative housing defining an electrical mating port and an optical mating port offset from the electrical mating port in both a mating direction and a vertical direction perpendicular to said mating direction;
a plurality of contacts disposed in the housing and exposed to the electrical mating port, and including at least one pair of differential contacts for transmitting differential signals, and at least one grounding contact aligned with the differential contacts along a transverse direction perpendicular to both the mating direction and the vertical direction;
an optical module assembled to the optical mating port, said optical module including a holder member, a plurality of optical coupling devices retained in the holder member, a plurality of rearwardly extending fibers connected to the corresponding optical coupling devices, respectively; and
a metallic resilient member retained in the optical mating port and constantly urging the optical coupling devices forwardly, wherein the resilient member is directly or indirectly electrically connected with the grounding contact to be grounded through the grounding contact.

13. The hybrid connector as claimed in claim 12, wherein the housing includes a base portion, a tongue portion extending forwardly into the electrical mating port from the base portion, a plurality of passageways recessed on the tongue portion and in communication with the electrical port, and a reception groove in communicating with one of the passageways in the vertical direction, the contacts have planner mating portions located in the passageways and exposed into the electrical port, the resilient member defines a compression coil spring sandwich between the optical module and the housing along the mating direction, and an abuting portion disposed in the reception groove to press onto the mating portion of the grounding contact.

14. The hybrid connector as claimed in claim 12, further comprising a metallic connect plate retained in the housing, and being in touch with the resilient member, the resilient member is isolated from the contacts, and includes a compression coil spring directly urging the optical module forwardly, the connect plate defines a retaining portion retained in the housing, an upright plate extending downwardly from the retaining plate, and an abuting plate extending downwardly to press onto the grounding contact from the retaining plate, the upright plate defines a cutout formed on a lower edge thereof to be attached on a post of the housing.

15. The hybrid connector as claimed in claim 14, wherein the housing includes a base portion, a tongue portion extending forwardly into the electrical mating port from the base portion, a depression recessed on the tongue portion and in communication with a rear part of the optical mating port, and a cover filled in the depression, the cover defines a notch formed on a front edge thereof and receiving an upper portion of the compression coil spring therein, the notch has two opposite side walls defining two opposite locating slots formed thereon to retaining two opposite side edges of the upright plate for being prevented from moving along the mating direction.

16. An electrical connector for mating with a complementary connector, comprising:
an insulative housing having thereof a platform to define an electrical area and an optical area at first and second levels, respectively;
a plurality of electrical contacts having stiff and resilient contacting sections thereof, and disposed in the housing at the first level; and
an optical module having fibers and lenses thereon, located at the second level, said optical module being back and forth movable relative to the housing in a mating direction; wherein
a metallic resilient device constantly urges the optical module forwardly under condition that said resilient device is electrically connected to a ground contact of said plurality of electrical contacts.

17. The electrical connector as claimed in claim 16, wherein said grounding contact has the stiff contacting section.

18. The electrical connector as claimed in claim 16, wherein said grounding contact is located offset from a center line of the housing in a transverse direction perpendicular to both said mating direction and said vertical direction.

19. The electrical connector as claimed in claim 18, wherein said resilient device is electrical connected to the grounding contact via a metallic plate indirectly or a end of said resilient device directly.

20. The electrical connector as claimed in claim 16, wherein the optical module is essentially located in front of the contacting sections of the electrical contacts under condition that the stiff contacting sections are located between the resilient contacting sections and the optical module in a vertical direction perpendicular to said mating direction.
